(19) United States
(12) Patent Application Publication
(10) Pub. No.: US 2020/0202002 A1
(43) Pub. Date: Jun. 25, 2020

(54) FIRMWARE SECURITY

(71) Applicant: HEWLETT-PACKARD DEVELOPMENT COMPANY, L.P., Spring, TX (US)

(72) Inventor: Christoph Graham, Houston, TX (US)

(21) Appl. No.: 16/481,879

(22) PCT Filed: Sep. 18, 2017
(86) PCT No.: PCT/US2017/051979

§ 371 Date: Jul. 30, 2019

(51) Int. Cl. G06F 21/57; G06F 21/14

(52) U.S. Cl. CPC G06F 21/572; G06F 21/14; G06F 2221/0748; G06F 2221/033; G06F 21/577

(57) ABSTRACT

Examples associated with firmware security are described. One example includes dividing a firmware image into a set of chunks. The chunks are sized to fit into memory blocks of a firmware memory of a device. Members of the set of chunks are assigned to respective memory blocks based on a first security value associated with the device. Members of the set of chunks are stored in their respective memory blocks to create a firmware content. The firmware content is obfuscated.

### BACKGROUND

The firmware of a device includes instructions that allow for control of the hardware of that device. In various examples, firmware may be used to start the device and/or its components, identify and/or communicate with components of the device and/or other devices connected to the device, serve as an interface between software on the device and device hardware, and so forth. Firmware may be stored in non-volatile memory of the device such as a read only memory (ROM), a flash memory, and so forth.

### BRIEF DESCRIPTION OF THE DRAWINGS

The present application may be more fully appreciated in connection with the following detailed description taken in conjunction with the accompanying drawings.

FIG. 1 illustrates an example device associated with firmware security.

FIG. 2 illustrates a flowchart of example operations associated with firmware security,

FIG. 3 illustrates an example system with firmware security.

FIG. 4 illustrates another example system associated with firmware security.

FIG. 5 illustrates a flowchart of example operations associated with firmware security.

FIG. 6 illustrates an example computing device in which example systems, and methods, and equivalents, may operate.

### DETAILED DESCRIPTION

Systems, methods, and equivalents associated with firmware security are described. When a vulnerability is discovered in a firmware of a device, this may comprise the firmware of other devices running similar firmware. This may allow malicious entities to purchase a device, discover how the firmware operates and how to take advantage of a vulnerability of that device, and then use that vulnerability to attack other devices running the firmware. In some examples, the vulnerability may allow the malicious entity to replace all or a portion of the firmware with malicious code. These attacks may allow the malicious entity to damage the devices, steal information from users of the devices, and so forth.

Consequently, it may be desirable to manufacture devices with firmware that is pseudo-unique to, each device such that the pseudo-uniqueness hinders a successful attack leading to many devices becoming similarly compromised. In one example, this may be achieved by taking a firmware image and segmenting the firmware image into chunks that fit into discrete blocks of the firmware memory. For each device, an assignment scheme may be used to assign the chunks pseudo-randomly to the different blocks of that devices firmware memory. The pseudo-random assignments may be based on a device identifier that is unique to each device. This may effectively randomize the order of the firmware image in the firmware memory of each device. When it comes time to load the firmware image into memory, the assignment scheme may then be recreated from the device identifier and used to load the chunks into a system memory in the correct order. As an additional measure the reordered firmware image may be obfuscated using, for example, a masking function to further hide the ordering of the firmware image in the firmware memory.

Various examples herein refer to pseudo-random techniques. As used herein, a pseudo-random technique is a technique that will produce statistically random results, despite being generated by a deterministic process. Thus, a pseudo-random technique may provide a way to repeatedly generate the same statistically random sequence each time the technique is fed a given input.

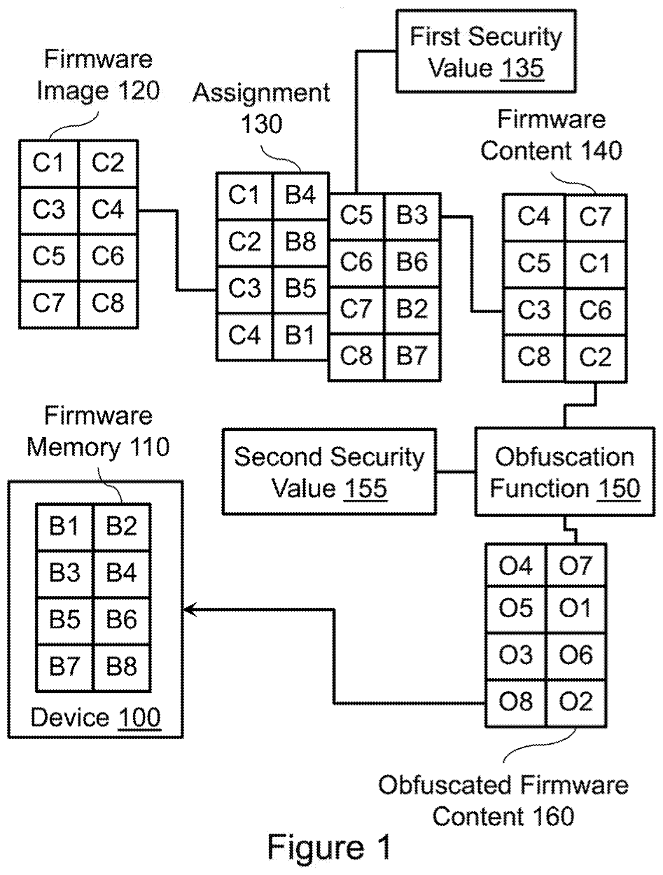

FIG. 1 illustrates an example device associated with firmware security. It should be appreciated that the items depicted in FIG. 1 are illustrative examples, and many different systems, devices, and so forth, may operate in accordance with various examples.

FIG. 1 illustrates an example device 100 associated with firmware, security. Device 100 includes a firmware memory 110 into which a firmware image 120 is to be stored. Firmware image 120 may include instructions associated with controlling various hardware components of device 100. In various examples, device 100 may be one of a type of mass produced device that each rely on the same firmware instructions embodied in firmware image 120. Thus, to hinder malicious attacks on device 100, as well as similarly manufactured devices, a process may be performed to randomize the ordering of chunks of firmware image 120 and to obfuscate the reordered firmware image 120 in device 100 and each other device manufactured to be the same or similar to device 100.

This may be achieved by dividing firmware image 120 into a set of chunks that will be stored in blocks of firmware memory 110 according to an assignment 130. The blocks may be addressable portions of firmware memory 110 that the chunks of firmware image 120 are sized to fit into. In this example, firmware image 120 is illustrated as being divided into eight chunks C1-C8, and firmware memory 110 is illustrated has having eight memory blocks B1-B8. To generate assignment 130, a first security value 135 may be used as a seed for a pseudo-random number generator that outputs assignment 130. A pseudo-random number generator may be used so that assignment 130 can be generated when device 100 is booted so that firmware image 120 can be reconstructed by device 100. In various examples, first security value 135 may be a value unique to device 100, a component thereof, and so forth. By way of illustration, first security value 135 may he a media access control address of device 100, a value associated with another component of device 100, a value created specifically for the purpose of generating assignment 130 and stored in a secure storage of device 100, and so forth.

Using assignment 130, the chunks of firmware image 120 may be reordered into a firmware content 140. Here chunks C1-C8 of firmware image 120 are shown in their ordering as firmware content 140 after being reordered according assignment 130. For example, chunk C4 of firmware image 120 is assigned to block B1 of firmware memory 110, which corresponds to the top left portion of firmware memory 110 as illustrated. Thus, firmware content 140 shows chunk C4 as being in the top left portion of firmware content 140.

In some examples firmware content 140 may be stored in firmware memory 110 and device 100 may be shipped in this state. However, a clever attacker may be able to figure out assignment 130 by carefully examining firmware memory 110. Consequently, it may be desirable to apply an obfuscation function 150 to firmware content 140 to create an obfuscated firmware content 160. In various examples, obfuscation function 150 may be a salt function that relies on a second security value 155. As with first security value 135, second security value 155 may be a value unique to device 100, a component thereof, and so forth. In some examples, second security value 155 and first security value 135 may be based on the same unique value. Second security value 155 may be used to generate a pseudo-random bit stream. Thus, the bit stream may be a series of ones and zeroes that is pseudo-randomly generated. An XOR operation may then be applied to the bit stream and firmware content 140 to create obfuscated firmware content 160, shown here as including obfuscated chunks O1-O8 in locations that correspond to the locations of chunks C1-C8 in firmware content 140. Once created, obfuscated firmware content 160 may then be stored in firmware memory 110.

Because the bit stream exhibits statistical randomness, it may be difficult to reconstruct firmware image 120 or even firmware content 140 from obfuscated firmware content 160. Further, using the XOR operation may eventually allow firmware content 140 to be reconstructed from obfuscated firmware content 160 and the bit stream because reapplying the XOR operation to obfuscated firmware content 160 and the bit stream may recreate firmware content 140. In other examples, obfuscation function may be an encryption function, may be applied to chunks collectively or individually, may be applied before or after applying assignment 130 to generate firmware content 140, and so forth.

To reconstruct firmware image 120 during, for, example, a startup of device 100, device 100 may perform several of the above described operations in reverse to ultimately load firmware image 120 to a memory at which point execution of firmware image 120 can take place. In an example where obfuscated firmware content 160 is stored in firmware memory 110, first, firmware content 140 may be, reconstructed. This may be achieved by recreating the pseudo-random bit stream, and applying an XOR operation between the pseudo-random bit stream and obfuscated firmware content 160. Assignment 130 may then be recreated using first security value 135, at which point chunks of firmware image 120 may be successively loaded into memory until firmware image 120 has been recreated.

As discussed above, the creation and use of obfuscated firmware content 160 may impede efforts by malicious entities from using an attack on a device to serve as a blueprint for attacking similarly manufactured devices. This may be because each device may use different security values for generating assignment 130 and in association with obfuscation function 150. This is because even if a malicious entity manages to attack and replace a firmware on their own device, the reordering and obfuscation of the firmware may be specific to that device. Consequently, repeating a similar attack on another device may involve obtaining the security values used to in generating assignment 130 and by obfuscation function 150. However, as these may be securely stored in a manner that limits access to processes running after a certain stages of startup, successfully generation of a potential malicious firmware image may be hindered.

In some examples, it may be desirable to perform an additional verification of firmware image 120 after it has been reconstructed from obfuscated firmware content 160. This may be achieved by storing a copy of firmware image 120 in a secure memory of device 100 (not shown). The secure memory may be, for example, an embedded controller. Verifying firmware image 120 against the copy may be an additional check against tampering with firmware image 120, thereby providing extra protection against malicious attacks on device 100. While the copy of firmware image 120 may be stored in the secure storage in its original state, in other examples, the copy of firmware image 120 may be stored after going through a similar process used to create obfuscated firmware content 160. This obfuscated copy may be created using the same first security value 135 and/or second security value 155, differing values, the obfuscation function 150, an alternative obfuscation function, a differing process for generating an assignment of chunks to blocks, and so forth.

It is appreciated that, in the following description, numerous specific details are set forth to provide a thorough understanding of the examples. However, it is appreciated that the examples may be practiced without limitation to these specific details. In other instances, methods and structures may not be described in detail to avoid unnecessarily obscuring the description of the examples. Also, the examples may be used in combination with each other.

“Module”, as used herein, includes but is not limited to hardware, firmware, software stored on a computer-readable medium or in execution on a machine, and/or combinations of each to perform a function(s) or an action(s), and/or fib cause a function or action from another module, method, and/or system. A module may include a software controlled microprocessor, a discrete module, an analog circuit, a digital circuit, a programmed module device, a memory device containing instructions, and so on. Modules may include gates, combinations of gates, or other circuit components. Where multiple logical modules are described, it may be possible to incorporate the multiple logical modules into one physical module. Similarly, where a single logical module is described, it may be possible to distribute that single logical module between multiple physical modules.

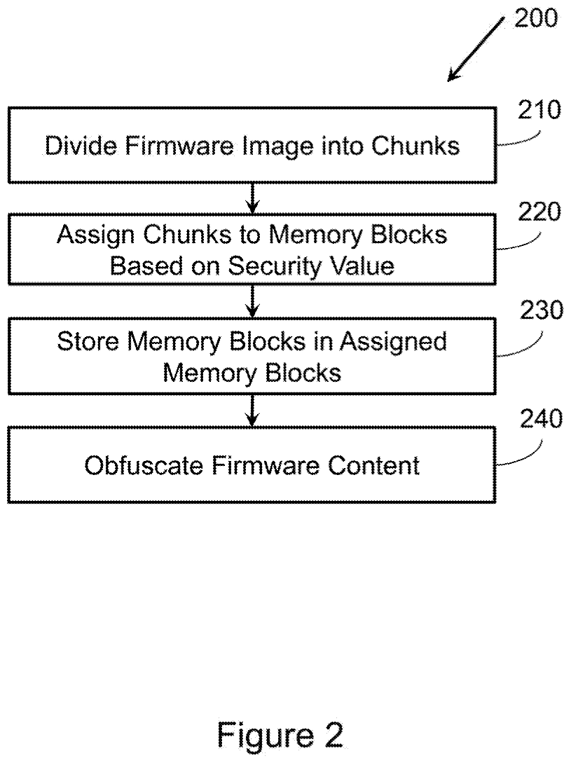

FIG. 2 illustrates an example method 200. Method 200 may be embodied on a non-transitory processor-readable medium storing processor-executable instructions. The instructions, when executed by a processor, may cause the processor to perform method 200. In other examples, method 200 may exist within logic gates and/or RAM of an application specific integrated circuit (ASIC).

Method 200 may perform various tasks associated with firmware security. Method 200 includes dividing a firmware image into a set of chunks at 210. Members of the set of chunks may be sized to fit into memory blocks of a firmware memory of a device. The firmware memory may be, for example, a read only memory, a flash memory, and so forth. In various examples the device may be a device including its own processor that will be able to perform various actions associated with recovering the firmware image. These devices, may include, personal computers, mobile devices, printers, and so forth. In other examples, the device may be a device without its own processor, in which case the firmware memory may provide instructions to a connected device that will control operation of the device. Here the device may be a peripheral such as, a mouse, or keyboard, a sensor, and so forth.

Method 200 also includes assigning members of the set of chunks to respective memory blocks at 220. The assignment may be based on a first security value associated with the device. The first security value may be a value unique to the device. By way of illustration, the first security value may be, a serial number of the device, a media access control (MAC) address, a universally unique identifier (UUID) of a system processor of the device, a serial number of a subcomponent of the device, a global system for mobile communications (GSM) radio identifier, a security processor identifier, and so forth. The assignment may be based on a pseudo-random function that uses the first security value as a seed. Thus, whenever the pseudo-random function is accessed using the first security value, the same assignment of chunks to blocks may be generated.

Method 200 also includes storing the members of the set of chunks in their respective memory blocks at 230. This may create a firmware content. Method 200 also includes obfuscating the firmware content at 240. The firmware content may be obfuscated using a salt function, encryption, and so forth. By way of illustration, obfuscating the firmware content may include using a one-way hash function on a second security value to generate a bit stream. An XOR operation may be applied to the bit stream and the firmware content to generate an obfuscated firmware content. The obfuscated firmware content may then be stored in the firmware memory. The second security value may be the same as the first security value. Storing the obfuscated firmware content may make it harder for a malicious entity from using a successful attack on the device from applying that attack to other, similarly manufactured devices relying on the same or a similar firmware.

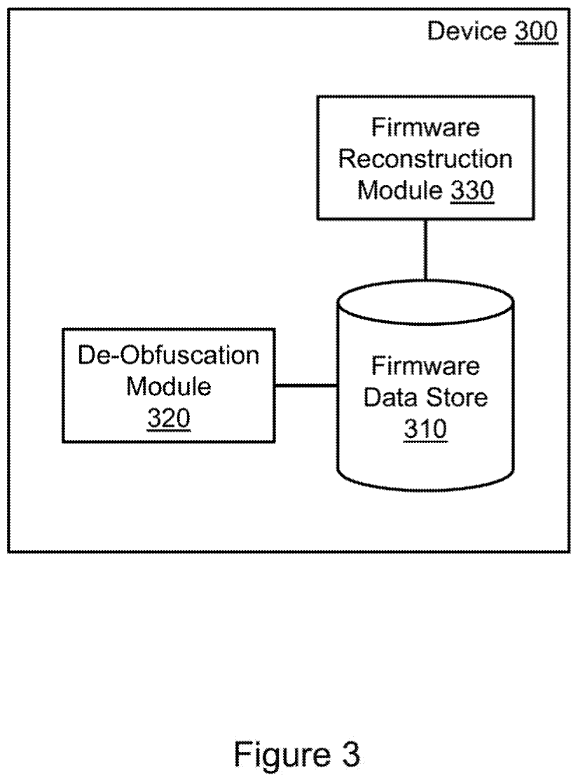

FIG. 3 illustrates a device 300 associated with firmware security. Device 300 includes a firmware data store 310. Firmware data store 310 may store firmware instructions having a first ordering. Firmware data store 310 may be divided into a set of addressable blocks. The firmware instructions may be segmented into a set of chunks that are stored in respective blocks of the firmware memory. The chunks may be stored in the respective blocks according to an assignment scheme that is based on a first security value associated with device 300. The chunks may also be, obfuscated based on a second security value associated with device 300.

Device 300 also includes a de-obfuscation module 320. De-obfuscation module 320 may use the second security value to de-obfuscate the chunks of firmware instructions. In various examples, the chunks may be individually obfuscated, collectively obfuscated, and so forth. Thus, the manner by which the chunks are de-obfuscated may depend on the technique by which the chunks have been obfuscated prior to being stored in firmware data store 310. By way of illustration, when the chunks are obfuscated by applying an XOR operation to the chunks and a bit stream generated from the second security value, the chunks may be re-obtained by re-applying the XOR operation to the obfuscated chunks and the bit stream after recreating the bit stream using the second security value.

Device 300 also includes a firmware reconstruction module 330. Firmware reconstruction module 330 may load the firmware instructions from firmware data store 310 for execution. This may be achieved by firmware reconstruction module 330 accessing the chunks from their respective blocks in an order determined based on the first security value so that the chunks are accessed according to the first ordering.

In some examples, firmware data store 310 may be a member of a set of firmware data stores 310. In these examples, each firmware data store 310 may store a respective set of firmware instructions that have been segmented into chunks and assigned to blocks of that firmware data store 310. In these examples, each firmware data store may be associated with a different component of device 300. Thus, assignment schemes for the firmware data stores 310 may be based on a single security value, based on differing security values, and so forth. When differing security values are used, the security values may correspond to component with which respective firmware data stores 310 are associated.

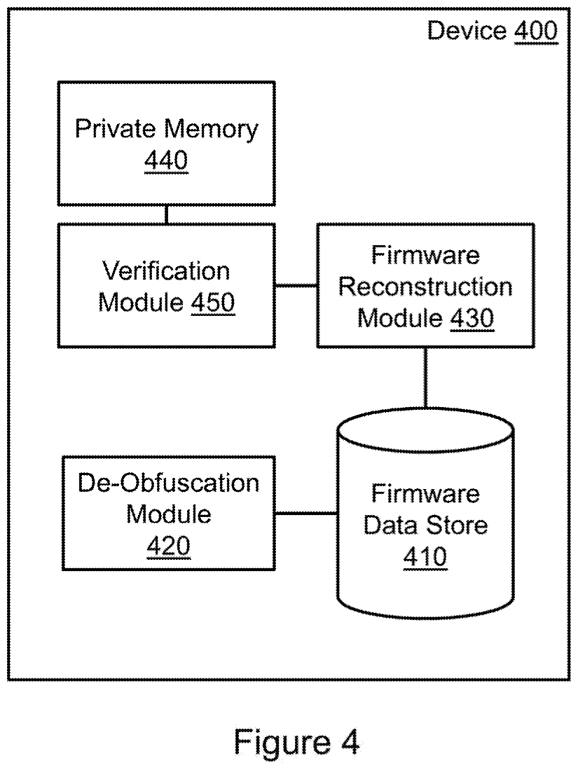

FIG. 4 illustrates another example device 400. Device 400 includes several items similar to those described above with reference to device 300 (FIG. 3). For example, device 400 includes a firmware data store 410, a de-obfuscation module 420, and a firmware reconstruction module 430.

Device 400 also includes a private memory 440. Private memory 440 may store a copy of the firmware instructions. The copy of the firmware instructions may be stored in reordered, obfuscated chunks. The reordering may be based on a third security value, and the obfuscation may be based on a fourth security value. However, two or more of the third security value, the fourth security value, a security value used for assigning chunks of firmware instructions to memory blocks of firmware data store 410 (e.g., a first security value), and a security value used for obfuscating firmware instructions in firmware data store 420 (e.g., a second security value) may be the same value.

Device 400 also includes a verification module 450. Verification module 450 may verify the firmware instructions loaded for execution prior to execution of the firmware instructions. The firmware instructions loaded for execution may be verified based on the copy of the firmware instructions. This may provide additional security for device 400 by adding additional security to the firmware image that prevents tampering with the firmware image.

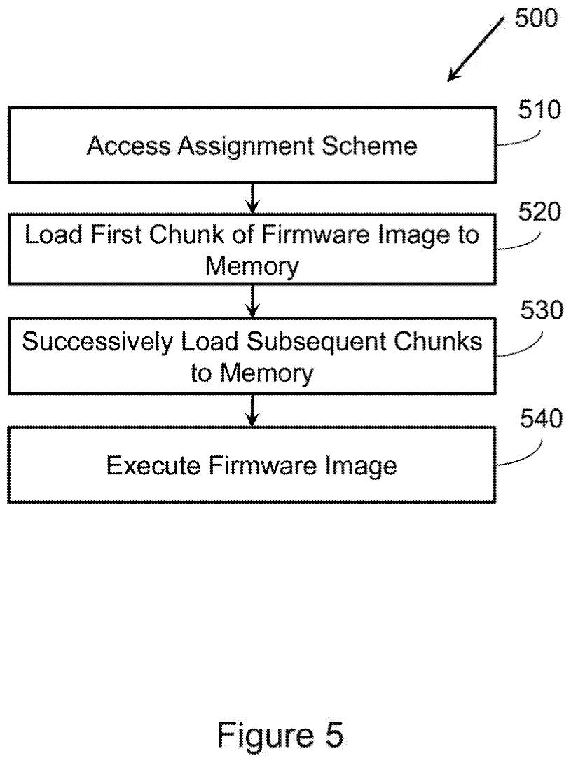

FIG. 5 illustrates a method 500 associated with firmware security. Method 500 includes accessing an assignment scheme at 510. The assignment scheme may map a set of ordered chunks of a firmware image to a set of memory blocks of a firmware memory. The ordered chunks may be stored into the memory blocks to which they are assigned. The assignment scheme may be based on a first security value associated with a device in which the firmware memory is embedded.

Method 500 also includes loading a first chunk of the firmware image at 520. The first chunk may be loaded to a system memory of the device. The first chunk may be loaded based on the assignment scheme.

Method 500 also includes successively loading subsequent chunks of the firmware image into the system memory of the device at 530. The subsequent chunks may be loaded based on the assignment scheme. The chunks may be loaded until the firmware image has been reconstructed in the system memory. Method 500 also include executing the firmware image at 540.

In some examples, the firmware image may be stored in the firmware memory in an obfuscated state. In these examples, method 500 may also include de-obfuscating the firmware image.

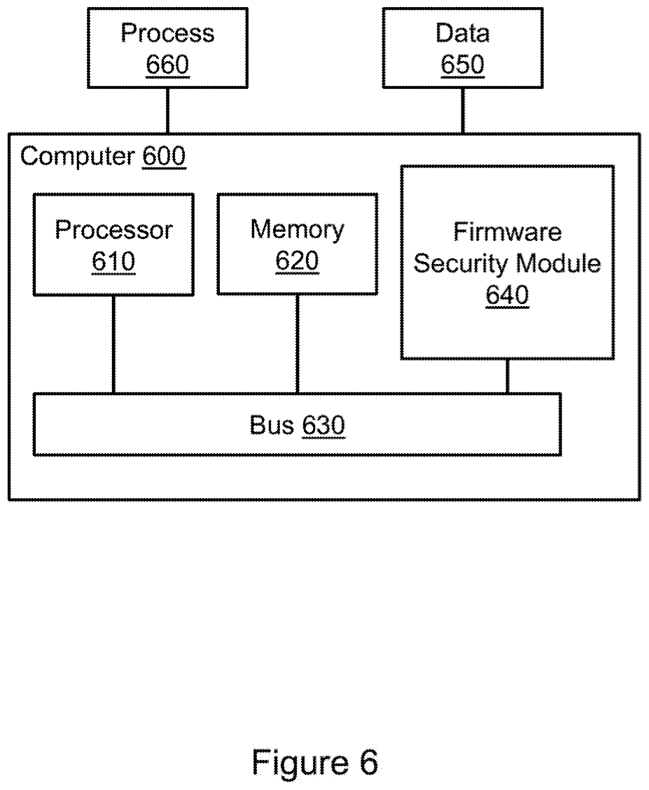

FIG. 6 illustrates an example computing device in which example systems and methods, and equivalents, may operate. The example computing device may be a computer 600 that includes a processor 610 and a memory 620 connected by a bus 630. Computer 600 includes a firmware security module 640. Firmware security module 640 may perform, alone or in combination, various functions described above with reference to the example systems, methods, and so forth. In different examples, firmware security module 640 may be implemented as a non-transitory computer-readable medium storing processor-executable instructions, in hardware, software, firmware, an application specific integrated circuit, and/or combinations thereof.

The instructions may also be presented to computer 600 as data 650 and/or process 660 that are temporarily stored in memory 620 and then executed by processor 610. Processor 610 may be a variety of processors including dual microprocessor and other multi-processor architectures. Memory 620 may include non-volatile memory (e.g., read-only memory) and/or volatile memory (e.g., random access memory). Memory 620 may also be, for example, a magnetic disk drive, a solid state disk drive, a floppy disk drive, a tape drive, a flash memory card, an optical disk, and so on. Thus, memory 620 may store process 660 and/or data 660. Computer 600 may also be associated with other devices including other computers, devices, peripherals, and so forth in numerous configurations (not shown).

It is appreciated that the previous description of the disclosed examples is provided to enable any person skilled in the art to make or use the present disclosure, Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A method, comprising:
dividing a firmware image into a set of chunks sized to fit into memory blocks of a firmware memory of a device;
assigning members of the set of chunks to respective memory blocks based, on a first security value associated with the device;
storing the members of the set of chunks in their respective memory blocks to create a firmware content; and
obfuscating the firmware content.

2. The method of claim 1 where the first security value is a value unique to the device.

3. The method of claim 2, where the first security value is one of, a serial number of the device, a media access control address, a universally unique identifier (UUID) of a system processor of the device, a serial number of a subcomponent of the device, a global system for mobile communications (GSM) radio identifier, and a security processor identifier.

4. The method of claim 1, where the firmware content is obfuscated using a salt function.

5. The method of claim 1, where obfuscating the firmware content includes using a one-way hash function on a second security value to generate a bit stream, applying an XOR operation between the bit stream and the firmware content to generate an obfuscated firmware content, and storing the obfuscated firmware content in the firmware memory.

6. A device, comprising:
a firmware data store for storing firmware instructions having a first ordering, where the firmware data store is divided into a s addressable blocks, where the firmware instructions are segmented into a set of chunks, where the chunks are stored in respective blocks of the firmware memory according to an assignment scheme based on a first security value associated with the device, and where the chunks are obfuscated based on a second security value associated with the device.
a de-obfuscation module to use the second security value to de-obfuscate the chunks of firmware instructions; and
a firmware reconstruction module to load the firmware instructions for execution by accessing the chunks from their respective blocks in an order determined based on the first security value so that the chunks are accessed in the first ordering.

7. The device of claim 6 where the chunks have been at least one of individually obfuscated and collectively obfuscated.

8. The device of claim 6, further comprising:
a private memory for storing a copy of the firmware instructions; and
a verification module for verify the firmware instructions loaded for execution using the copy of the firmware instructions prior to execution of the firmware instructions loaded for execution.

9. The device of claim 8, where the copy of the firmware instructions are stored in reordered, obfuscated chunks, where the reordering is based on a third security value, and where the obfuscation is based on a fourth security value.

10. The device of claim 9, where the third security value is the same as the first security value and where the fourth security value is the same as the second security value.

11. The device of claim where the firmware data store is a member of a set of firmware data stores, each storing a respective set of firmware instructions that have been segmented into chunks that are assigned, according to respective assignment schemes, to blocks of the member of the set of firmware data stores in which the respective set of firmware in ructions is stored.

12. The device of claim 11, where, the respective assignment schemes are based on the first security value.

13. The device of claim 11, where the respective assignment schemes are based on security values associated with respective components of the device for which the member of the set of firmware provides instructions.

14. A method, comprising:
accessing an assignment scheme that maps a set of ordered chunks of a firmware image to a set of memory blocks of a firmware memory into which the ordered chunks have been stored, where the assignment scheme is based on a first security value associated with a device in which the firmware memory is embedded;
loading, based on the assignment scheme, a first chunk of the firmware image to a system memory of the device;
successively loading, based on the assignment scheme, subsequent chunks of the firmware image into the system memory of the device until the firmware image has been reconstructed in the system memory; and
executing the firmware image.

15. The method of claim 14, where the firmware image is stored in the firmware memory in an obfuscated state and where the method further comprises de-obfuscating the firmware image.
